(19) United States
(12) Patent Application Publication
(10) Pub. No.: US 2021/0151812 A1
(43) Pub. Date: May 20, 2021

(54) BATTERY MODULE AND VEHICLE WITH THE SAME

(71) Applicant: Farasis Energy (Ganzhou) Co., Ltd., Ganzhou (CN)

(72) Inventors: Wubing Ye, Hayward, CA (US); Zane Bodenbender, Hayward, CA (US); Tanner Devoe, Hayward, CA (US); Mark Goldman, Hayward, CA (US)

(73) Assignee: Farasis Energy (Ganzhou) Co., Ltd., Ganzhou (CN)

(21) Appl. No.: 16/951,171

(22) Filed: Nov. 18, 2020

Related U.S. Application Data
(60) Provisional application No. 62/937,151, filed on Nov. 18, 2019.

(51) Int. Cl. H01M 10/48; H01M 2/10

(52) U.S. Cl. CPC H01M 10/486; H01M 2220/20; H01M 2/1077; H01M 10/482

(57) ABSTRACT

The present disclosure relates to the field of battery, and discloses a battery module and a vehicle with the same, the battery module comprising a plurality of battery cells (1), a first flexible printed circuit assembly (FPCA) (2) and a thermistor FPCA (4), the first FPCA (2) including a flexible substrate, and voltage sense lines connected with voltage sense tabs (21) and temperature sense lines connected with temperature sense tabs (22) formed on the flexible substrate; wherein the voltage sense tabs (21) are electrically connected to a positive terminal (11) or a negative terminal (12) of the battery cells (1) to measure the voltage of the battery cells (1); the thermistor FPCA (4) includes a temperature sensor (41) and connection tabs (42), the temperature sensor (41) is arranged to abut the battery cells (1), the connection tabs (42) are connected to the temperature sense tabs (22) so as to transmit the temperature signals detected by the temperature sensor (41) to the temperature sense lines.

### CROSS REFERENCE TO RELATED APPLICARTIONS

The application claims the benefit of United States (US) provisional application No. 62/937,151, filed on Nov. 18, 2019, entitled “Battery Module with Integrated Flexible Circuit Board sensor Lines”, the content of which is entirely incorporated herein by reference.

### FIELD

The present disclosure relates to the field of battery, in particular to a battery module. On this basis, the present disclosure also involve with a vehicle having the battery module.

### BACKGROUND

The countries around the world have promulgated a variety of policies for reducing carbon emission due to the increasing awareness of environmental protection concept, the electric vehicles powered by vehicle-mounted power supplies have gradually recognized and valued by the general public. In order to meet the travel demands, the high-output and large-capacity battery technology has played an important role in the development of the Battery Electric Vehicles (BEVs) and the Hybrid Electric Vehicles (HEVs). For this purpose, it is generally required to use a battery system consisting of a plurality of battery modules connected in series or in parallel as a power source for driving the electric vehicles and performing other operations thereof.

The abnormal state of the battery cells, such as over-charge and over-discharge, may cause serious safety accidents; for the sake of monitoring the limit temperature and the operation condition of the battery cells, it is necessary to utilize a battery management system to monitor the parameters of battery cells such as voltage, current, temperature in real time, so as to ensure that the battery system is safely and effectively used. Typically, a battery module used in an electric vehicle is integrally provided with sense lines such that the monitored voltage, temperature and other parameters are transmitted to the battery management system. Such sense lines may be arranged in various forms such as a wire, a Printed Circuit Board (PCB) and a Flexible Printed Circuit Board (FPCB). For example, The U.S. Pat. No. 9,024,572 B2 discloses a battery module provided with a voltage detection circuit, wherein voltage sense lines are integrated on a flexible printed circuit substrate for monitoring the voltage of the battery cells, thereby alleviating the layout complexity of the voltage sense line.

However, the above battery module requires to arrange a flexible printed circuit board provided with voltage sense lines and temperature sense lines according to the terminal arrangement and position of the battery cells, and a wiring extending from the temperature detection element is connected with the temperature sense lines, and makes the temperature detection element to be thermally coupled with a side surface of the battery pack. In this case, it is necessary to appropriately connect a plurality of wirings extending from the temperature detecting element with the temperature sense lines on the flexible printed circuit board during the design and production process, the assembly process is complicated and the production efficiency is low.

### SUMMARY

The present disclosure aims to solve the problems of complex assembly process and low production efficiency of the battery module in the prior art, and provides a battery module, which may allow parts to be easily assembled and has the advantages of desirable design flexibility and high production efficiency.

In order to achieve the above objects, a first aspect of the present disclosure provides a battery module comprising: a plurality of battery cells connected in series and/or in parallel with each other; a first flexible printed circuit assembly (FPCA) including a flexible substrate, and voltage sense lines connected with voltage sense tabs and temperature sense lines connected with temperature sense tabs formed on the flexible substrate; the voltage sense tabs are electrically connected with a positive terminal or a negative terminal of the battery cells to measure a voltage of the battery cells; a thermistor FPCA including a flexible substrate, and a temperature sensor and connection tabs spaced apart and electrically connected with each other through conductive traces formed on the flexible substrate, wherein the temperature sensor is arranged to abut the battery cells, and the connection tabs are connected to the temperature sense tabs so as to transmit the temperature signals detected by the temperature sensor to the temperature sense lines.

Through the aforementioned technical scheme, the battery module of the present disclosure is provided with a first FPCA and a thermistor FPCA which are relatively independent, the geometric shape and size of each flexible printed circuit board can be designed as required, and the corresponding tabs can be connected with each other by means of laser welding and the like. The FPC system in the battery module is broken down into a plurality of smaller parts, so as to adapt with the different arrangement of the battery cells and be reliably positioned and connected, increase the design flexibility without compromising the production efficiency due to large and complex shapes of the battery module.

### BRIEF DESCRIPTION OF THE DRAWINGS

FIG. 1 is a perspective view of a battery module according to a preferred embodiment of the present disclosure, wherein the side plates are removed;

FIG. 2 is a perspective view of the battery module of FIG. 1, wherein the cover plate is removed;

FIG. 3 is a perspective view of a first FPCA of the battery module of FIG. 1;

FIG. 4 illustrates a schematic diagram of the first FPCA of FIG. 3 in an expanded state, wherein the connectors are removed;

FIG. 5 is a perspective view of a second FPCA of the battery module of FIG. 1;

FIGS. 6a and 6b respectively illustrate the perspective views of the thermistor FPCA of the battery module of FIG. 1;

FIG. 7 is a schematic diagram illustrating the connection relationship of the first FPCA with the busbar and the thermistor FPCA.

### DESCRIPTION OF REFERENCE SIGNS

1—battery cell

11—positive terminal

12—negative terminal

2—first FPCA

21—voltage sense tab

22—temperature sense tab

23—connector

24—notched slot

25—heat stake

26—laser welding spot

2a—main body

2b—branch part

2c—crease

2d—ridge

3—-second FPCA

4—thermistor FPCA

41—temperature sensor

42—connection tab

5—end plate

6—side plate

61—venting holes

62—mounting base

7—cover plate

8—busbar

### DETAILED DESCRIPTION

The specific embodiments of the present disclosure will be described in detail below with reference to examples. It should be comprehended that the specific embodiments described herein merely serve to illustrate and explain the present disclosure, instead of imposing a limitation thereto.

In the present disclosure, unless otherwise specified, the use of directional terms such as “upper, lower, left and right” generally means upper part, lower part, left side and right side as illustrated in the reference drawings; “inner and outer” refer to the inside and outside relative to the profile of the individual component per se.

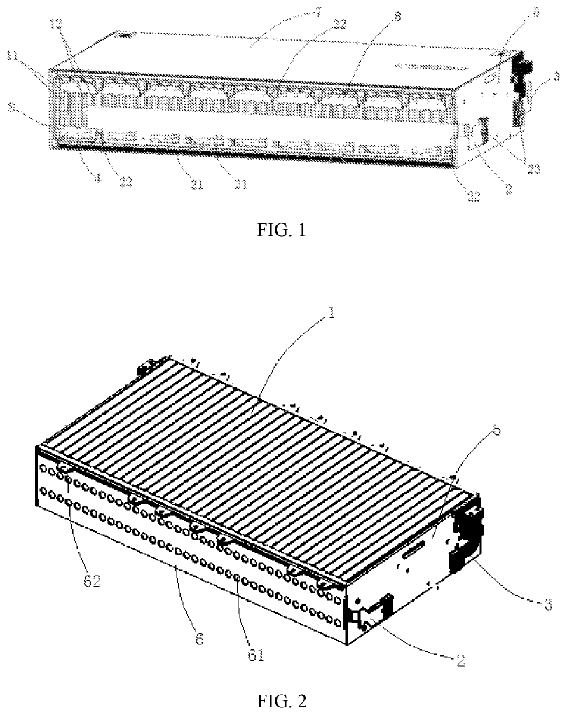

Referring to FIG. 1 and FIG. 2, a battery module according to a preferred embodiment of the present disclosure includes a plurality of battery cells 1 and a plurality of integrally provided flexible printed circuits. The plurality of battery cells 1 are connected in series or in parallel with each other in order to provide high voltage or large capacity power. Each of the plurality of Flexible Printed Circuits (FPCs) is provided with a flexible substrate, conductive traces formed on the flexible substrate, and tabs for connecting with each other or other parts (e.g., a battery cell), whereby the monitored parameters such as voltage and temperature of the battery cell 1 can be transmitted.

The battery module of the present disclosure is provided with a first FPCA 2, a second FPCA 3, and a plurality of thermistor FPCAs 4, wherein the conductive traces formed on the flexible substrate of the first FPCA 2 comprise voltage sense lines and temperature sense lines, and voltage sense tabs 21 electrically connected to the voltage sense lines and temperature sense tabs 22 electrically connected to the temperature sense lines are led out; the voltage sense tabs 21 are electrically connected to the positive terminal 11 or the negative terminal 12 of the battery cells 1 so as to measure the voltage of the corresponding battery cells 1. As shown in FIG. 6a and FIG. 6b, the thermistor FPCA 4 includes a temperature sensor 41 and connection tabs 42 which are spaced apart and electrically connected with each other through conductive traces on the flexible substrate, and the temperature sensor 41 is arranged to abut the battery cells 1 in order to detect the temperature of the battery cells 1. The connection tab 42 of the thermistor FPCA 4 are connected to the temperature sense tabs 22 of the first FPCA 2, so as to transmit the temperature signals detected by the temperature sensor 41 to the temperature sense lines.

Therefore, the FPC is used in the present disclosure for monitoring the voltage and temperature parameter of the battery cells 1, the use of FPC allows for a more integrated design with fewer components, more shape flexibility, and ability for high volume automated assembly which is not feasible with the PCB detection components. In particular, by forming the thermistor FPCA 4 relatively independently of the first FPCA 2 applied as the main sense line, it is possible to easily perform positioning and mounting of each components in the assembly process, thereby avoiding a problem that the mounting position is inaccessible in the later assembly step. In the meanwhile, the FPC system is broken down into a plurality of smaller parts, so that the FPC system can be conveniently set into the geometric shape and size, and easier to manufacture and adapt to the battery module with complex appearance, thus the FPC system has better design flexibility and higher production efficiency. The temperature detecting element formed as a flexible printed circuit (thermistor FPCA 4) can be easily electrically connected with the first FPCA 2, thereby facilitating the automated production.

Continue with reference to FIG. 1 and FIG. 2, in order to prevent safety accidents such as damage or explosion of the battery module caused by the battery cells 1 suffering from mechanical impact or moisture corrosion during the manufacture or use process, a plurality of battery cells 1 are generally arranged in a stacked manner, such as being adjacent to each other and aligned in a column along a horizontal direction, so as to utilize an outer casing and wrap the battery cells 1 therein for protection. In this circumstance, the positive terminal 11 and the negative terminal 12 may be disposed at the end parts in each of the battery cells 1.

The outer casing may include a pair of end plates 5, a pair of side plates 6, and a cover plate 7 and a bottom plate, which are oppositely disposed, respectively. The side plates 6 in the battery module shown in FIG. 1 are removed in order to illustrate the arrangement of the first FPCA 2 and the other components therein; the cover plate 7 of the battery module shown in FIG. 2 is removed to illustrate the stacked state of the plurality of battery cells 1. The end plates 5 are disposed at both ends of the battery cells 1 along the stacking direction, the side plates 6 are disposed along the stacking direction and oppositely arranged in regard to the positive terminal 11 and the negative terminal 12 of the battery cells 1, the cover plate 7 and the bottom plate are covered on the upper and lower sides of the battery cells 1 along the stacking direction. Therefore, the battery module as a whole is in a cuboid structure, such that a power supply system for the electric vehicle can be formed by stacking a plurality of battery modules.

In the illustrated embodiment, the side plates 6 are formed with a plurality of venting holes 61 and mounting bases 62, the venting holes may be to allow gas to vent out the module during thermal runaway, so as to reduce the energy generated from a failed cell from propagating toward adjacent cells; the mounting bases can be used for fixation and installation of the battery module.

According to the preferred embodiment of the present disclosure, the battery cells in the battery module are flat and have a shape of long strip, a plurality of battery cells are stacked for each other along the thickness direction, a positive terminal 11 and a negative terminal 12 are disposed at both ends of each battery cell along the length direction. For this purpose, a second FPCA 3 is further provided at the other end opposite to the first FPCA 2, the second FPCA 3 and the first FPCA 2 extend inside the side plate 6 respectively and are bent toward each other at the junction of the side plate 6 and the end plate 5, so as to connect an external monitoring system outside the end plate 5 by means of, for example, a connector 23. For this reason, a slot allowing the FPC to pass out may be formed at the edge of the side plate 6 or the end plate 5 in order to prevent abrasion during operation.

In order to facilitate implementation of the assembly process, the first FPCA 2 and the second FPCA 3 may be respectively attached to an end of the battery cell 1 by using a double-sided adhesive tape, so as to initially locate the mounting position and perform the subsequent electrical connection step with the battery cell 1 or the thermistor FPCA 4.

A plurality of battery cells 1 may be connected with each other in series or in parallel through the busbar 8 or in an end-to-end manner. In the illustrated preferred embodiment, the voltage sense tabs 21 of the first FPCA 2 and the second FPCA 3 are connected to the busbar 8, and are electrically connected with the positive terminal 11 or the negative terminal 12 of the battery cells 1 through the busbar 8. In this case, only the voltage of a group of parallel cells may be measured.

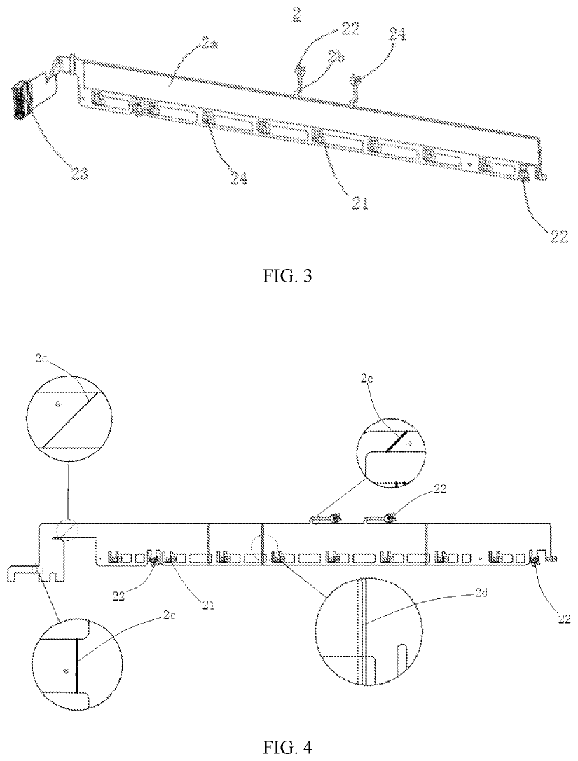

Referring to FIG. 3 and FIG. 4, the first FPCA 2 applied to the foregoing battery module includes a main body 2a and branch parts 2b extending from a side of the main body 2a. The side of the main body 2a is provided with a plurality of, e.g. nine, voltage sense tabs 21 and a plurality of, e.g. four, temperature sense tabs 22, wherein the voltage sense tabs 21 can be electrically connected with the positive terminal 11 and the negative terminal 12 of the battery cell 1 through the busbar 8; the temperature sense tabs 22 are connected with the connection tab 42 of thermistor FPCA 4. Here, each metal tab may be integrated on the flexible substrate and connected to the conductive traces through a variety of suitable means such as soldering, crimping, etching along the conductive traces, etc.

The branch parts 2b may be folded along the crease 2c to extend away from the main body 2a, wherein a part of temperature sense tabs 22 are disposed on the branch part 2b so as to connect with the thermistor FPCA 4 at a distant position. The flexible substrate may also be folded along the crease 2c at a location near the connector 23 to enable the flexible substrate to be cut from a long strip of the raw material, thereby reducing formation of the scrap material.

According to the preferred embodiment of the present disclosure—a plurality of ridges 2d may be formed on the main body 2a, with a reserved length allowing for extension. As strain-relief bends, the ridges 2d are to account for thermal expansion/contraction of the module and modifying the module length after the FPC is assembled due to process parameters.

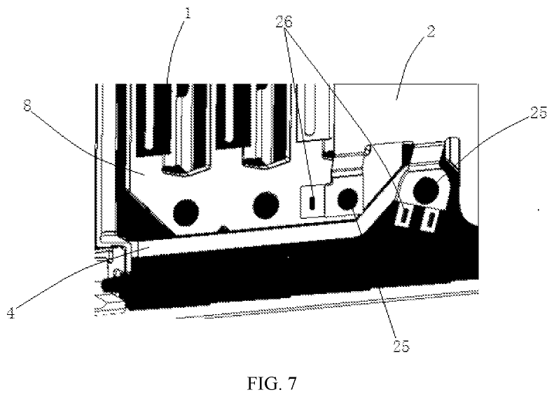

A notched slot 24 may be formed in the first FPCA 2 at a position adjacent to the voltage sense tabs 21 and the temperature sense tabs 22, and the first FPCA 2 may be connected to the busbar 8 or the thermistor FPCA 4 through a heat stake 25 (see FIG. 7) disposed in the notched slot 24. Furthermore, the voltage sense tabs 21 may be connected to the busbar 8 by laser welding, and the temperature sense tabs 22 are connected with the connection tab 42 of thermistor FPCA 4 by laser welding, thereby forming the laser welding spot 26, whereby the voltage parameter, and the temperature parameter sensed by the temperature sensor 41 (e.g., a thermistor) on the thermistor FPCA 4 can be transmitted to the external monitoring system through the laser welding spot 26 and the connector 23. Pre-fixing the FPC to the busbar 8 via the heat stake 25 can provide a fastening for alignment of subsequent laser welding and form additional mechanical durability.

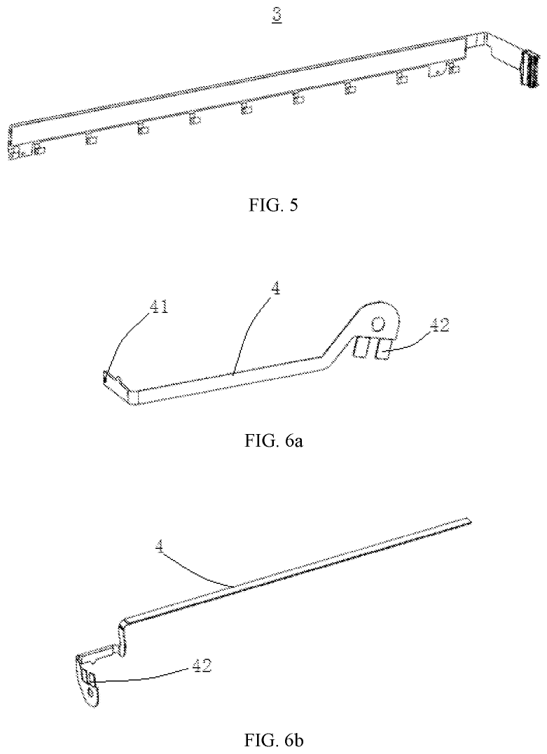

FIG. 5 illustrates a second FPCA 3 applied to the foregoing battery module. The second FPCA 3 has the substantially same structure as the first FPCA 2, both have voltage sense tabs, a connector and the like, except that a temperature sense tab connected to the thermistor FPCA 4 is not provided in the second FPCA 3. It is understandable that since the conductive traces on the FPC are independent from each other, the second FPCA 3 is not necessary for detecting the voltage of the battery cell in some other embodiments. For example, when the busbars or the battery cell terminals are only on one side of the module, the battery module may be simply integrated with a first FPCA 2, and the voltage sense tabs 21 connected with different battery terminals are led out, such an arrangement can also be used for performing the voltage measurement of the battery cells.

FIG. 6a and FIG. 6b illustrate the thermistor FPCA 4 applied at different locations in the foregoing battery module, respectively, wherein the parts extending between the temperature sensor 41 and the connection tab 42 have different shapes and size, so that the parts can be adapted to the surface of the battery cell 1 at different positions and can be flexibly arranged according to the requirements of temperature measurement. For example, the thermistor FPCA 4 shown in FIG. 6a may extend along the stacking direction and measure the temperature at the side of the battery cell 1; the thermistor FPCA 4 shown in FIG. 6b can extend along the length direction of the battery cell 1 and measure the temperature at the side of the battery cell 1 towards the cover plate 7.

FIG. 7 specifically illustrates the connection relationship of the battery cells 1, the busbar 8, the first FPCA 2 and the thermistor FPCA 4, wherein the busbar 8 connects the positive terminals and negative terminals of the plurality of battery cells 1, so that the plurality of battery cells 1 are connected in parallel to each other. A first FPCA 2 is fastened on the busbar 8 through a heat stake 25, and enables the voltage sense tabs 21 to be electrically connected with the busbar 8 through a laser welding spot 26, so as to measure the voltage of the group of battery cells 1; the first FPCA 2 is fixedly connected with the thermistor FPCA 4 via the heat stake 25, and allows the temperature sense tab 22 to be electrically connected with the connection tab 42 of the thermistor FPCA 4 through the laser welding spot 26, such that the temperature of said battery cell 1 can be measured through the temperature sensor 41 on the thermistor FPCA 4.

According to the above content, the battery module of the present disclosure may connect a plurality of thermistor FPCAs 4 with the first FPCA 2 which is regarded as a main sense line, so as to conveniently measure the battery temperature at different positions. It can effectively improve design flexibility of the detection circuit in the manufacture of large or complex battery modules without generating obviously adverse influence on the production efficiency.

On the basis, the present disclosure also provides a vehicle comprising the aforementioned battery module.

The above content describes the preferred embodiments of the present disclosure in detail with reference to the accompanying drawings, but the present disclosure is not limited thereto. A variety of simple modifications can be made in regard to the technical solutions of the present disclosure within the scope of the technical concept of the present disclosure, including a combination of individual specific technical features in any suitable manner. For the sake of avoiding the unnecessary repetition, a variety of possible combination modes are not further formulated in the present disclosure. However, such simple modifications and combinations thereof shall also be regarded as the content disclosed by the present disclosure, each of them falls into the protection scope of the present disclosure.

1. A battery module, comprising:
a plurality of battery cells (1) connected in series and/or in parallel with each other;
a first FPCA (2) including a flexible substrate, and voltage sense lines connected with voltage sense tabs (21) and temperature sense lines connected with temperature sense tabs (22) formed on the flexible substrate; the voltage sense tabs (21) are electrically connected with a positive terminal (11) or a negative terminal (12) of the battery cells (1) to measure the voltage of the battery cells (1);
a thermistor FPCA (4) including a flexible substrate, and a temperature sensor (41) and connection tabs (42) spaced apart and electrically connected with each other through conductive traces formed on the flexible substrate, wherein the temperature sensor (41) is arranged to abut the battery cells (1), and the connection tabs (42) are connected to the temperature sense tabs (22) so as to transmit the temperature signals detected by the temperature sensor (41) to the temperature sense lines of the first FPCA (2).

2. The battery module of claim 1, wherein the plurality of battery cells (1) are arranged in a stacked manner, the positive terminal (11) and the negative terminal (12) are disposed at the end parts in each of the battery cells (1).

3. The battery module of claim 2, wherein the battery module comprises a pair of end plates (5) disposed at both ends of the battery cells (1) along a stacking direction, a pair of side plates (6) disposed along the stacking direction and oppositely arranged in regard to the positive terminal (11) and the negative terminal (12), and a cover plate (7) and a bottom plate respectively covered on the upper and lower sides of the battery cells (1) along the stacking direction.

4. The battery module of claim 3, wherein the side plates (6) are formed with venting holes (61) and/or mounting bases (62) thereon.

5. The battery module of claim 3, wherein the battery module comprises a second FPCA (3), the second FPCA (3) and the first FPCA (2) are arranged opposite each other at both ends of the battery cell (1) towards the side plate (6), and are bent towards each other at the junction of the side plate (6) and the end plate (5).

6. The battery module of claim 5, wherein the first FPCA (2) and the second FPCA (3) are respectively attached to an end of the battery cells (1) by a double-sided adhesive tape, and/or, the ends of the first FPCA (2) and the second FPCA (3) which are bent towards each other are respectively provided with a connector (23) for connecting with an external monitoring system.

7. The battery module of claim 2, wherein the battery cells (1) are grouped and each group of the battery cells (1) is provided with a busbar (8) connecting to the positive terminal (11) and/or the negative terminal (12), the voltage sense tabs (21) are connected to the busbar (8).

8. The battery module of claim 7, wherein the first FPCA (2) is formed with a notched slot (24), and is connected to the busbar (8) or the thermistor FPCA (4) through a heat stake (25) disposed in the notched slot (24), and/or wherein the voltage sense tabs (21) are connected to the busbar (8) through laser welding and the temperature sense tabs (22) are connected with the connection tab (42) through laser welding.

9. The battery module of claim 1, wherein the first FPCA (2) comprises a main body (2a) and branch parts (2b) extending from a side of the main body (2a), the branch parts (2b) are folded to extend away from the main body (2a), at least a part of the temperature sense tabs (22) are disposed in the branch parts (2b).

10. A vehicle comprising a battery module, wherein the battery module comprise:
a plurality of battery cells (1) connected in series and/or in parallel with each other;
a first FPCA (2) including a flexible substrate, and voltage sense lines connected with voltage sense tabs (21) and temperature sense lines connected with temperature sense tabs (22) formed on the flexible substrate; the voltage sense tabs (21) are electrically connected with a positive terminal (11) or a negative terminal (12) of the battery cells (1) to measure the voltage of the battery cells (1);
a thermistor FPCA (4) including a flexible substrate, and a temperature sensor (41) and connection tabs (42) spaced apart and electrically connected with each other through conductive traces formed on the flexible substrate, wherein the temperature sensor (41) is arranged to abut the battery cells (1), and the connection tabs (42) are connected to the temperature sense tabs (22) so as to transmit the temperature signals detected by the temperature sensor (41) to the temperature sense lines of the first FPCA (2).
